(19) United States
(12) Patent Application Publication
(10) Pub. No.: US 2017/0070008 A1
(43) Pub. Date: Mar. 9, 2017

(54) CONNECTOR SOCKET AND CONNECTOR

(71) Applicant: FUJITSU LIMITED, Kawasaki-shi (JP)

(72) Inventor: Masato SOGA, Tokorozawa (JP)

(73) Assignee: FUJITSU LIMITED, Kawasaki-shi (JP)

(21) Appl. No.: 15/246,979

(22) Filed: Aug. 25, 2016

(30) Foreign Application Priority Data
Sep. 4, 2015 (JP) 2015-174522

(51) Int. Cl. H01R 13/6585; H01R 13/6471; H01R 13/422

(52) U.S. Cl. CPC H01R 13/6585; H01R 13/4223; H01R 13/6471

(57) ABSTRACT

A connector socket includes: a main body including a plurality of terminal putting parts; a plurality of terminals put on the respective terminal putting parts; and a first shield member attached to the main body, the plurality of terminals includes one or more ground terminals each including a protruding part that protrudes to outside of the main body and is in contact with the first shield member, and one or more signal terminals that are not in contact with the first shield member, each of the one or more ground terminals and each of the one or more signal terminals are formed to be attachable to the plurality of terminal putting parts.

### CROSS-REFERENCE TO RELATED APPLICATION

This application is based upon and claims the benefit of priority of the prior Japanese Patent Application No. 2015-174522, filed on Sep. 4, 2015, the entire contents of which are incorporated herein by reference.

### FIELD

The embodiments discussed herein are related to a connector socket and a connector.

### BACKGROUND

An interface for display signal transmission mounted in mobile equipment such as a mobile phone terminal and a notebook personal computer (PC) includes MIPI, eDP, and so forth. MIPI is an abbreviation of mobile industry processor interface and eDP is an abbreviation of embedded display port. Along with increase in the definition of the display in recent years, the transmission speed by the MIPI, the eDP, and so forth has reached approximately 5 Gbps.

A related art is disclosed in Japanese Laid-open Patent Publication No. 2013-41771.

### SUMMARY

According to an aspect of the embodiments, a connector socket includes: a main body including a plurality of terminal putting parts; a plurality of terminals put on the respective terminal putting parts; and a first shield member attached to the main body, the plurality of terminals includes one or more ground terminals each including a protruding part that protrudes to outside of the main body and is in contact with the first shield member, and one or more signal terminals that are not in contact with the first shield member, each of the one or more ground terminals and each of the one or more signal terminals are formed to be attachable to the plurality of terminal putting parts.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is one example of a perspective view of a connector;

FIG. 2 illustrates one example of a perspective view of a socket illustrated in FIG. 1;

FIG. 3 illustrates one example of a partial enlarged view of the socket illustrated in FIG. 2;

FIG. 4 illustrates one example of a top view of the socket illustrated in FIG. 2;

FIG. 5 illustrates one example of a partial enlarged view of the socket illustrated in FIG. 4;

FIG. 6 illustrates one example of a bottom view of the socket illustrated in FIG. 2;

FIG. 7 illustrates one example of a sectional view along line VII-VII in FIG. 5;

FIG. 8 illustrates one example of a front view of a ground terminal illustrated in FIG. 7;

FIG. 9 illustrates one example of a front view of a signal terminal illustrated in FIG. 7;

FIG. 10 illustrates one example of a sectional view of a state before terminals are attached to the socket illustrated in FIG. 7;

FIG. 11 illustrates one example of a perspective view of a header illustrated in FIG. 1;

FIG. 12 illustrates one example of a top view of the header illustrated in FIG. 11;

FIG. 13 illustrates one example of a bottom view of the header illustrated in FIG. 11;

FIG. 14 illustrates one example of a sectional view along line XIV-XIV in FIG. 12;

FIG. 15 illustrates one example of a sectional view of a state before terminals are attached to the header illustrated in FIG. 14;

FIG. 16 illustrates one example of a perspective view representing a connector;

FIG. 17 illustrates one example of a front view of the connector illustrated in FIG. 16;

FIG. 18 illustrates one example of a sectional view perpendicular to a left-right direction of the connector illustrated in FIG. 16;

FIG. 19 illustrates one example of a top view of a socket illustrated in FIG. 16;

FIG. 20 illustrates one example of a top view of a socket of a connector; and

FIG. 21 illustrates one example of a top view of a socket of a connector.

### DESCRIPTION OF EMBODIMENTS

Regarding the transmission speed, higher speed exceeding 10 Gbps is expected in order to be compatible with 8K video in the future. For example, in order to reduce the deterioration of the signal quality due to superposition of noise on a signal line, a shield sheet metal, an electrically-conductive sheet, a noise filter, or the like is used. Due to the mounting of these parts, the size of the whole device increases and thus it might be difficult to respond to requests for size reduction from end users. The deterioration of the signal quality is reduced by decreasing the transmission speed. However, high-definition and smooth rendering might not be carried out.

Similarly, an analog signal typified by an audio signal of mobile equipment deteriorates in the quality due to superposition of noise. For example, when noise is superimposed on an audio signal, it becomes difficult to ensure the sound quality and thus it might become difficult to hear sounds. Therefore, the interconnect of the analog signal is electrically blocked from other interconnects on a substrate. For example, if plural substrates are coupled by a stacking connector, an analog signal might suffer noise from another signal at the connector. Similarly to a noise countermeasure of a display signal, a noise countermeasure using a shield sheet metal, an electrically-conductive sheet, a noise filter, or the like is applied. However, the size of the whole device might increase.

A radio circuit mounted in mobile equipment is used to receive radio waves of various communication systems such as cellular, television (TV), global positioning system (GPS), radio, and Bluetooth (registered trademark). The radio circuit of the mobile equipment receives a weak radio signal, e.g. a radio signal of −50 dBm or lower. When noise is superimposed on the received signal, decoding becomes difficult and thus trouble might be caused in a voice call and data communications or trouble might be caused in transmission of video, sound, and position information. Also in this case, a countermeasure of using a shield sheet metal, an electrically-conductive sheet, a noise filter, or the like or adding a low noise amplifier is applied. However, the size of the whole device might increase. Through size reduction of mobile equipment, equipment of a wristwatch type or an ear-hook type is provided for example. The radio circuit corresponding to Bluetooth (registered trademark) and so forth is mounted also in such mobile equipment. Therefore, a small-size stacking connector including a noise shield may be required.

The stacking connector includes ground terminals besides signal terminals. A socket (receptacle) of the stacking connector includes a mold member on which the signal terminals are put and a shield member disposed on a lateral side of the mold member, and the ground terminals are formed monolithically with the shield member. In the stacking connector, signal interference in the connector is reduced. However, it might be difficult to change the arrangement of the signal terminals and the ground terminals because the ground terminals are monolithic with the shield member. For example, in order to change the terminal arrangement of the socket, large-scale equipment such as a mold, a molding machine, and a jig corresponding to the new terminal arrangement is prepared. Therefore, a lot of cost and time might be taken.

As a connector including a connector socket, a stacking connector used for coupling of two substrates is exemplified. For example, the connector socket is attached to one substrate and a connector header that can join to the connector socket is attached to the other substrate. The connector socket may be any as long as the connector socket includes plural terminals for signal transmission. For example, the connector socket may be used also for coupling between a substrate and a flexible substrate.

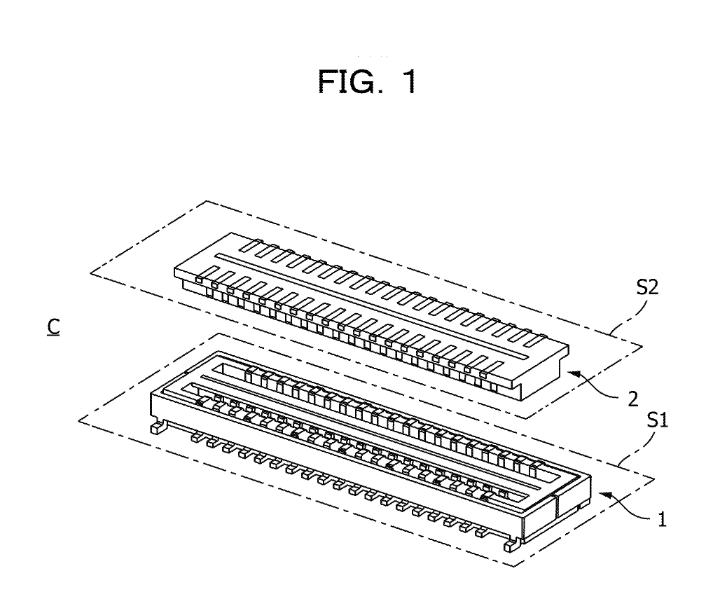

FIG. 1 illustrates one example of a perspective view of a connector. As illustrated in FIG. 1, a connector C may include a connector socket 1 and a connector header 2 that can join to each other, and the connector socket 1 and the connector header 2 are attached to main surfaces of different substrates S1 and S2, respectively. Hereinafter, the connector socket 1 and the connector header 2 will be referred to as the socket 1 and the header 2. For example, a socket of a connector will be called a receptacle in some cases and a header of a connector will be called a plug in some cases. In FIG. 1, a state in which the socket 1 and the header 2 are separated from each other is illustrated.

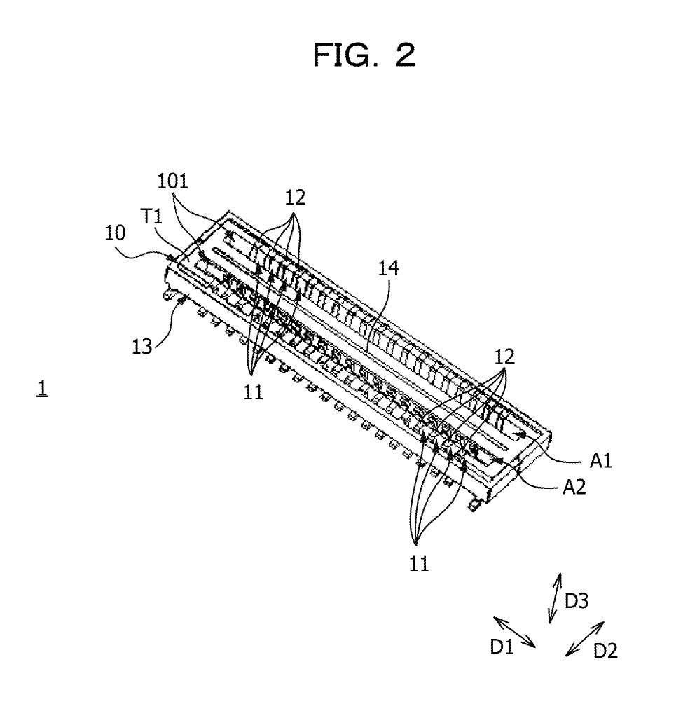

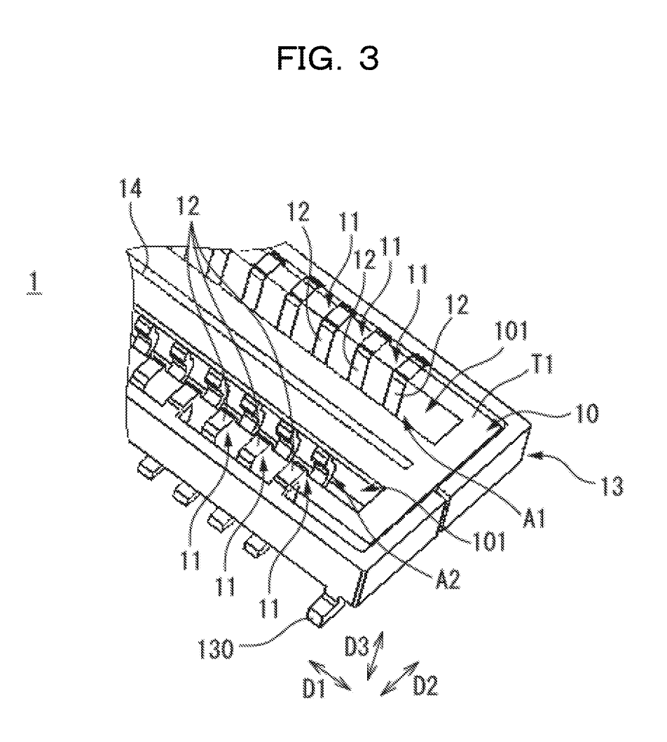

FIG. 2 illustrates one example of a perspective view of the socket illustrated in FIG. 1. FIG. 3 illustrates one example of a partial enlarged view of the socket illustrated in FIG. 2. As illustrated in FIG. 2 and FIG. 3, the socket 1 includes a rectangular main body 10 having a top surface T1 in which two groove-shaped recess parts 101 are made and plural terminals 12 disposed along the longitudinal direction of the main body 10. The socket 1 includes a frame-shaped side shield 13 attached to the main body 10 in such a manner as to surround the periphery of the main body 10 and a central shield 14 that is disposed at the central part of the main body 10 in the width direction and has a flat plate shape.

The side shield 13 may be one example of a ground shield member of the connector socket. The central shield 14 may be one example of another ground shield member of the connector socket. Hereinafter, the longitudinal direction of the main body 10 will be referred to as the left-right direction and the width direction of the main body 10 will be referred to as the front-rear direction. The direction perpendicular to both the left-right direction and the front-rear direction will be referred to as the upward-downward direction. In FIG. 2 and FIG. 3, the left-right direction, the front-rear direction, and the upward-downward direction are represented by arrows D1, D2, and D3, respectively (this is the same also in other diagrams).

As illustrated in FIG. 2 and FIG. 3, the plural terminals 12 form two rows juxtaposed in the front-rear direction and nineteen terminals 12 disposed at equal intervals in the left-right direction are included in each row. For example, the socket 1 illustrated in FIG. 2 is a socket for a dual-in-line connector in which the number of terminals is thirty eight. Hereinafter, the two rows will be referred to as first and second terminal rows A1 and A2 and the places at which the respective terminals 12 are put in the main body 10 will be referred to as terminal putting parts 11. The plural terminal putting parts 11 of the main body 10 form two rows extending along the left-right direction and nineteen terminal putting parts 11 disposed at substantially equal intervals are included in each row. The main body 10 may include various insulating materials and may be formed by injection molding of a resin material for example.

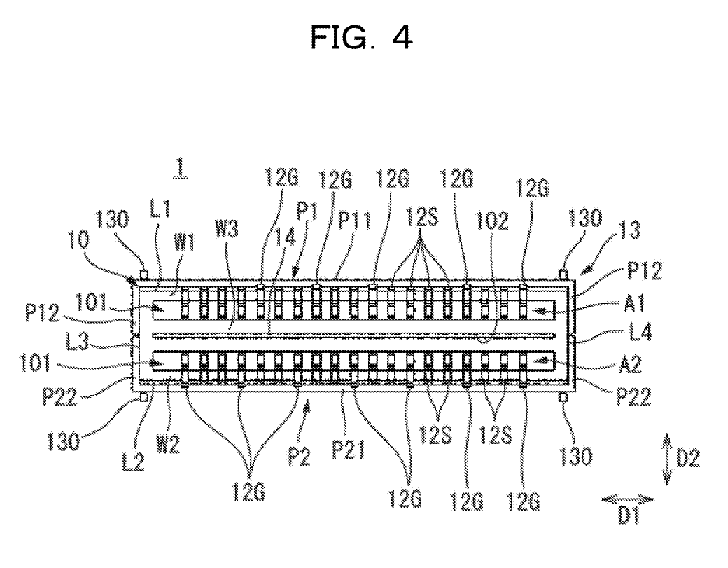

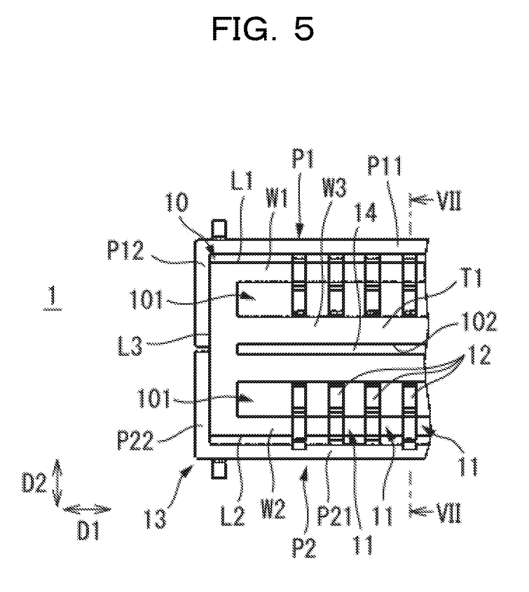

FIG. 4 illustrates one example of a top view of the socket illustrated in FIG. 2. FIG. 5 is a partial enlarged view of the socket illustrated in FIG. 4. As illustrated in FIG. 4 and FIG. 5, each recess part 101 of the main body 10 is formed between wall parts extending along the left-right direction. For example, one recess part 101 is formed between a first sidewall W1 including a first side surface L1 of the front-rear direction of the main body 10 and a central wall W3 located at the central part of the main body 10 in the front-rear direction. The other recess part 101 is formed between a second sidewall W2 including a second side surface L2 of the front-rear direction of the main body 10 and the central wall W3. Each recess part 101 of the main body 10 houses one part of each terminal 12. Furthermore, each recess part 101 houses one part of the header 2 when the socket 1 is joined to the header 2.

In FIG. 4, ground terminals 130 are provided at four corners of the frame-shaped side shield 13 and each ground terminal 130 is coupled to a ground terminal on the side of the substrate to which the socket 1 is attached. In FIG. 4 and FIG. 5, the side shield 13 may include a first part P1 opposed to the first side surface L1 of the main body 10 and a second part P2 opposed to the second side surface L2 of the main body 10. The first part P1 of the side shield 13 includes an extending part P11 that extends along the first side surface L1 of the main body 10 and perpendicular parts P12 that extend from both end parts of the extending part P11 in the left-right direction perpendicularly to the extending part P11. Similarly, the second part P2 of the side shield 13 includes an extending part P21 that extends along the second side surface L2 of the main body 10 and perpendicular parts P22 that extend from both end parts of the extending part P21 in the left-right direction perpendicularly to the extending part P21.

In FIG. 4, the perpendicular parts P12 and P22 of the side shield 13 are each anchored to side surfaces L3 and L4 of the left-right direction of the main body 10. The perpendicular parts P12 and P22 are fixed to the side surfaces L3 and L4 of the main body 10 by a fixing tool such as a fixing screw or a fixing pin or are bonded to the side surfaces L3 and L4 of the main body 10. The side shield 13 may be anchored to the main body 10 through fitting of the main body 10 to the inside of the first and second parts P1 and P2. The extending parts P11 and P21 of the side shield 13 are separated from the side surfaces L1 and L2, respectively, of the front-rear direction of the main body 10. Hereinafter, the extending part P11 of the first part P1 may be referred to as the first extending part P11 and the extending part P21 of the second part P2 may be referred to as the second extending part P21. The side shield 13 may include various electrically-conductive materials and may be formed by bending processing of a metal material for example.

In FIG. 4, the plural terminals 12 in the respective terminal rows A1 and A2 include ground terminals 12G that are electrically coupled to the extending part P11 or P21 of the adjacent side shield 13 and signal terminals 12S that are not electrically coupled to the side shield 13. For example, the first terminal row A1 may include five ground terminals 12G and fourteen signal terminals 12S, and the second terminal row A2 may include seven ground terminals 12G and twelve signal terminals 12S. In FIG. 4, the terminal arrangement in the first terminal row A1 is {S, S, S, S, G, S, S, G, S, S, G, S, S, S, S, G, S, S, G} from the left to the right. The terminal arrangement in the second terminal row A2 is {G, S, S, G, S, S, G, S, S, G, S, S, G, S, S, G, S, S, G}. The above-described S represents the signal terminal 12S and the above-described G represents the ground terminal 12G.

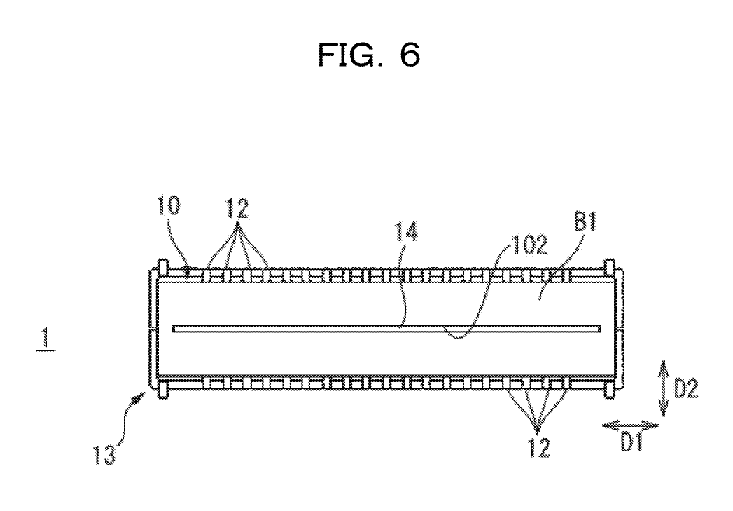

FIG. 6 illustrates one example of a bottom view of the socket illustrated in FIG. 2. As illustrated in FIG. 4 to FIG. 6, a slit 102 extending along the left-right direction is made at the central part of the main body 10 in the front-rear direction and the central shield 14 is disposed in the slit 102. In FIG. 4, the slit 102 and the central shield 14 of the main body 10 extend along the left-right direction over the entire length of the recess parts 101 of the main body 10. In FIG. 5 and FIG. 6, the slit 102 penetrates the main body 10 in the upward-downward direction. Thus, the end surfaces of the central shield 14 in the upward-downward direction are exposed from the top surface T1 and a bottom surface B1 of the main body 10, respectively. The end surface of the central shield 14 exposed from the bottom surface B1 of the main body 10 is coupled to a ground terminal on the side of the substrate to which the socket 1 is attached. The central shield 14 may include various metal materials similarly to the side shield 13.

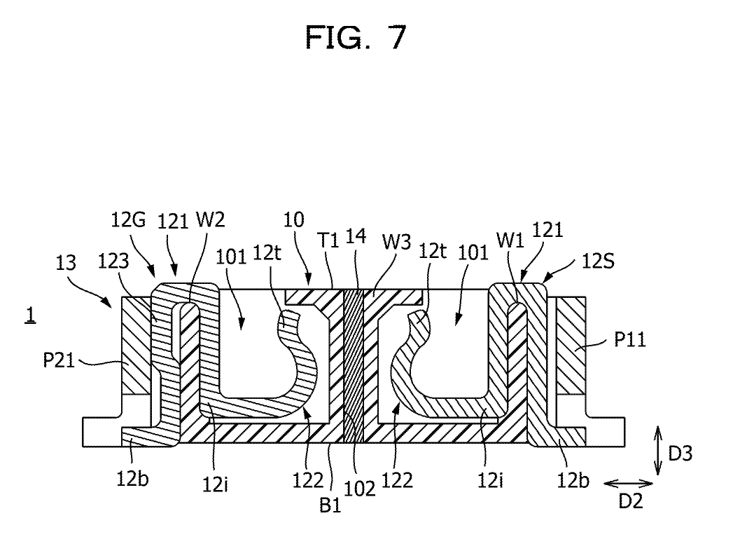

FIG. 7 illustrates one example of a sectional view along line VII-VII in FIG. 5. In the section in FIG. 7, the ground terminal 12G is disposed adjacent to the second extending part P21 of the side shield 13 and the signal terminal 12S is disposed adjacent to the first extending part P11 of the side shield 13. As illustrated in FIG. 7, each of the ground terminal 12G and the signal terminal 12S includes a base end part 12b located below the extending part P11 or P21 of the corresponding side shield 13 and a tip part 12t close to the central wall W3 inside the corresponding recess part 101. Each of the ground terminal 12G and the signal terminal 12S includes an intermediate part 12i in contact with the corresponding sidewall W2 or W1 inside the corresponding recess part 101. The base end parts 12b of the respective terminals 12G and 12S are coupled to a circuit network on the substrate to which the socket 1 is attached. The tip parts 12t of the respective terminals 12G and 12S are coupled to the respective terminals on the side of the header 2 when the socket 1 is joined to the header 2.

As illustrated in FIG. 7, the ground terminal 12G includes a folded-back part 121 that extends from the base end part 12b to the intermediate part 12i in such a manner as to straddle the corresponding sidewall W2 of the main body 10 and a curving part 122 that extends from the intermediate part 12i to the tip part 12t with a hook shape. As illustrated in FIG. 7, the folded-back part 121 of the ground terminal 12G includes a protruding part 123 that protrudes outward in the front-rear direction to get contact with the corresponding extending part P21 of the side shield 13. Similarly to the ground terminal 12G, the signal terminal 12S includes a folded-back part 121 that extends from the base end part 12b to the intermediate part 12i in such a manner as to straddle the corresponding sidewall W1 of the main body 10 and a curving part 122 that extends from the intermediate part 12i to the tip part 12t with a hook shape. The folded-back part 121 of the signal terminal 12S has a simple reverse U-shape and therefore might not include a part in contact with the side shield 13 like the protruding part 123. For example, the folded-back part 121 of the signal terminal 12S does not get contact with the corresponding extending part P11 of the side shield 13.

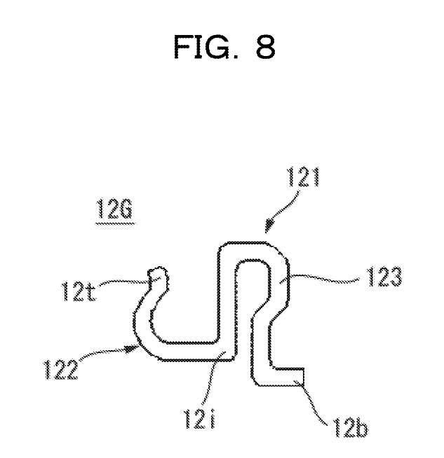

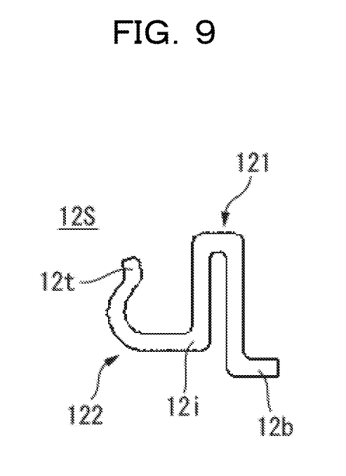

FIG. 8 illustrates one example of a front view of the ground terminal in FIG. 7. FIG. 9 illustrates one example of a front view of the signal terminal illustrated in FIG. 7. As is understood through comparison between FIG. 8 and FIG. 9, the ground terminal 12G may have substantially the same shape as the signal terminal 12S except for the above-described protruding part 123. The ground terminal 12G and the signal terminal 12S may include various electrically-conductive materials and may be formed by bending processing of a metal material such as copper or aluminum for example. For example, the ground terminal 12G and the signal terminal 12S may be formed monolithically with the main body 10 made of a resin.

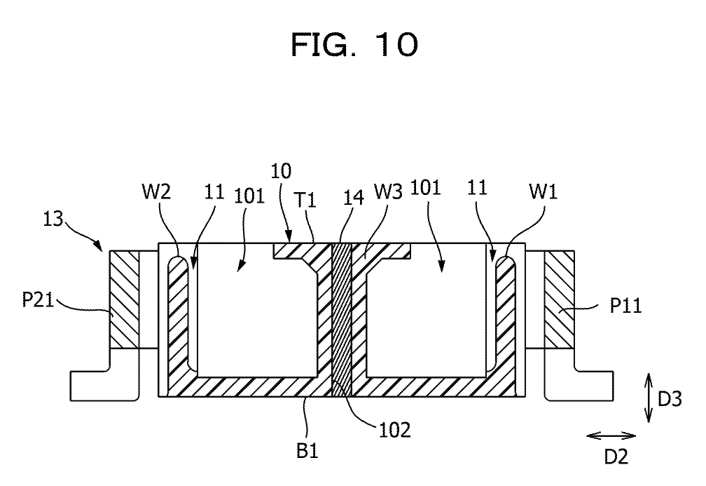

FIG. 10 illustrates one example of a sectional view of a state before the ground terminal and the signal terminal are attached to the socket illustrated in FIG. 7. As illustrated in FIG. 10, the terminal putting parts 11 of the main body 10 have a form of an engagement groove that is formed on the respective sidewalls W1 and W2 and has a reverse U-shape. This engagement groove may be formed to be capable of engaging with the folded-back part 121 of the respective terminals 12G and 12S (see also FIG. 7). In the socket 1, the terminal putting part 11 for the ground terminal 12G and the terminal putting part 11 for the signal terminal 12S may have substantially the same structure. In FIG. 7, the respective terminals 12G and 12S are put on the main body 10 by press-fitting. For example, the folded-back parts 121 of the respective terminals 12G and 12S engage with the terminal putting parts 11 (engagement grooves) of the corresponding sidewalls W2 and W1 and thereby the respective terminals 12G and 12S are put on the main body 10.

In FIG. 2 and FIG. 3, the main body 10 of the socket 1 includes the plural terminal putting parts 11 lined up on two rows in the front-rear direction and all terminal putting parts 11 have substantially the same structure. As illustrated in FIG. 8 and FIG. 9, the ground terminal 12G may have substantially the same structure as the signal terminal 12S except for one part (protruding part 123) of the folded-back part 121. For example, each of the ground terminals 12G and the signal terminals 12S may be formed to be capable of being put on any of the plural terminal putting parts 11 of the main body 10. Therefore, in the socket 1, the terminal arrangement on the main body 10 might be arbitrarily changed by merely interchanging the ground terminal 12G or the signal terminal 12S put on the individual terminal putting part 11.

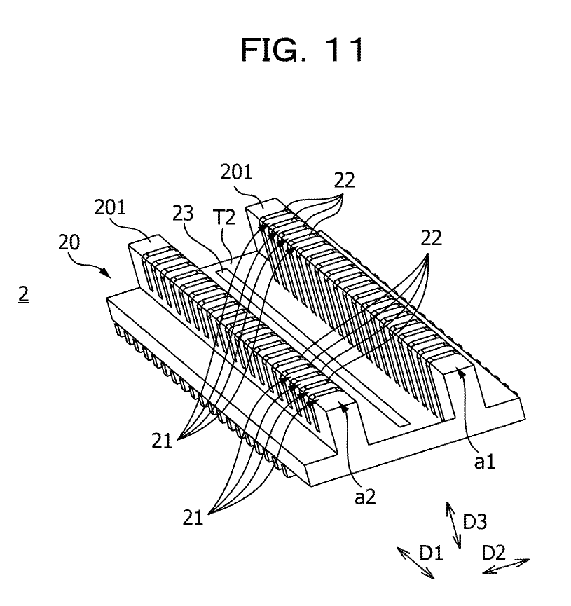

FIG. 11 illustrates one example of a perspective view of the header illustrated in FIG. 1. FIG. 11 is a diagram when a top surface T2 of the header 2 opposed to the top surface T1 of the socket 1 when the socket 1 is joined to the header 2 is viewed from an oblique upper side. As illustrated in FIG. 11, the header 2 includes a rectangular main body 20 having the top surface T2 on which two bump parts 201 are provided, and plural terminals 22 disposed along the longitudinal direction of the main body 20. Moreover, the header 2 includes a central shield 23 that is disposed at the central part of the main body 20 in the width direction and has a flat plate shape. Hereinafter, as with the description about the socket 1, the longitudinal direction of the main body 20 of the header 2 will be referred to as the left-right direction and the width direction of the main body 20 will be referred to as the front-rear direction. The direction perpendicular to both the left-right direction and the front-rear direction will be referred to as the upward-downward direction. In FIG. 11, the left-right direction, the front-rear direction, and the upward-downward direction are represented by the arrows D1, D2, and D3, respectively (this is the same also in other diagrams).

As illustrated in FIG. 11, the plural terminals 22 form two rows juxtaposed in the front-rear direction and nineteen terminals 22 disposed at equal intervals in the left-right direction are included in each row. For example, the header 2 illustrated in FIG. 11 is a header for a dual-in-line connector corresponding to the socket 1 illustrated in FIG. 2. Hereinafter, the above-described two rows will be referred to as first and second terminal rows a1 and a2 and the places at which the respective terminals 22 are put in the main body 20 will be referred to as terminal putting parts 21. The plural terminal putting parts 21 of the main body 20 form two rows juxtaposed in the front-rear direction and nineteen terminal putting parts 21 disposed at equal intervals in the left-right direction are included in each row. The main body 20 may include various insulating materials and may be formed by injection molding of a resin material for example.

As with each terminal 12 on the side of the socket 1, each terminal 22 on the side of the header 2 has a function of either the signal terminal or the ground terminal. For example, the terminal 22, from among the terminals 22 on the side of the header 2, that gets contact with the signal terminal 12S on the side of the socket 1 when the header 2 is joined to the socket 1 comes to have the function of the signal terminal on the side of the header 2. Similarly, the terminal 22, from among the terminals 22 on the side of the header 2, that gets contact with the ground terminal 12G on the side of the socket 1 when the header 2 is joined to the socket 1 comes to have the function of the ground terminal on the side of the header 2. All of the plural terminals 22 on the side of the header 2 may have substantially the same shape.

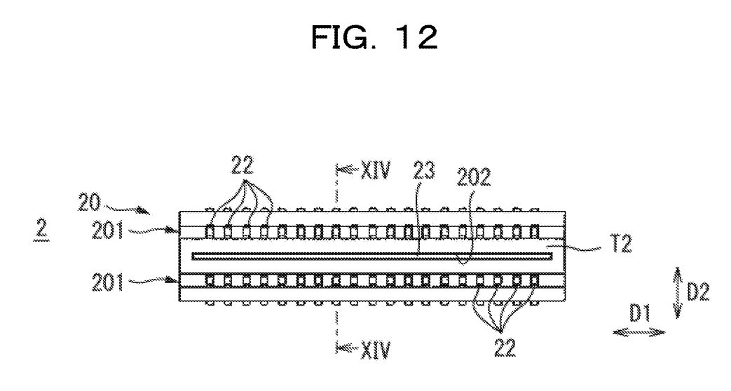

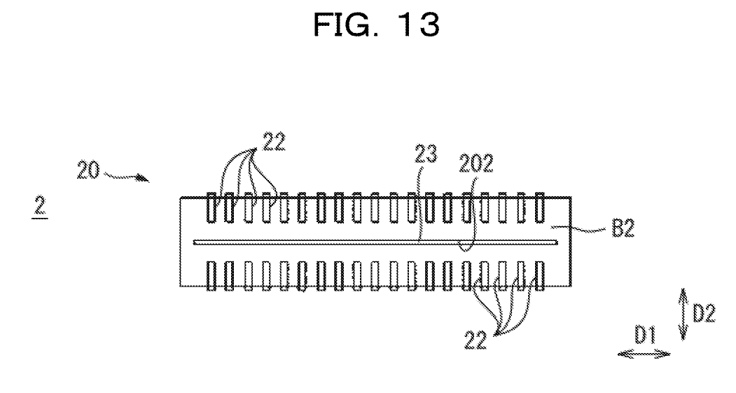

As illustrated in FIG. 11, the two bump parts 201 are disposed to be juxtaposed in the front-rear direction and each bump part 201 is formed to be capable of being fitted into each recess part 101 on the side of the socket 1. FIG. 12 illustrates one example of a top view of the header illustrated in FIG. 11. FIG. 13 illustrates one example of a bottom view of the header illustrated in FIG. 11. As illustrated in FIG. 12 and FIG. 13, a slit 202 is made at the central part of the main body 20 in the front-rear direction and the above-described central shield 23 is disposed in the slit 202. The slit 202 and the central shield 23 of the main body 20 extend in the left-right direction along the bump parts 201. The slit 202 penetrates the main body 20 in the upward-downward direction. Thus, the end surfaces of the central shield 23 in the upward-downward direction are exposed from the top surface T2 and a bottom surface B2 of the main body 20, respectively. The end surface of the central shield 23 exposed from the bottom surface B2 of the main body 20 is coupled to a ground terminal on the side of the substrate to which the header 2 is attached. The central shield 23 may include various electrically-conductive materials.

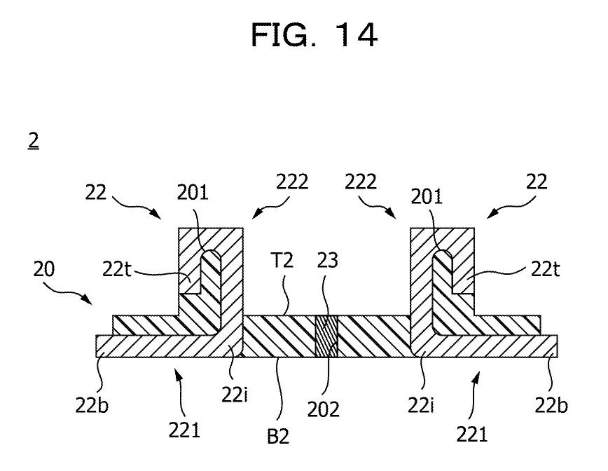

FIG. 14 illustrates one example of a sectional view along line XIV-XIV in FIG. 12. As illustrated in FIG. 14, each terminal 22 of the header 2 includes a base end part 22b that protrudes outward in the front-rear direction from the main body 20, an intermediate part 22i located inside the main body 20, and a tip part 22t in contact with the outer side surface of the corresponding bump part 201 of the main body 20. The base end part 22b of each terminal 22 is coupled to a circuit network on the substrate to which the header 2 is attached. The tip part 22t of each terminal 22 is coupled to the terminal 12 on the side of the socket 1 when the header 2 is joined to the socket 1.

As illustrated in FIG. 14, each terminal 22 of the header 2 may include a straight line part 221 that extends from the base end part 22b to the intermediate part 22i along the front-rear direction and a folded-back part 222 that extends from the intermediate part 22i to the tip part 22t in such a manner as to straddle the corresponding bump part 201 of the main body 20. Each terminal 22 on the side of the header 2 may include various electrically-conductive materials and may be formed by bending processing of a metal material such as copper or aluminum for example. For example, the terminals 22 on the side of the header 2 may be formed monolithically with the main body 20 made of a resin.

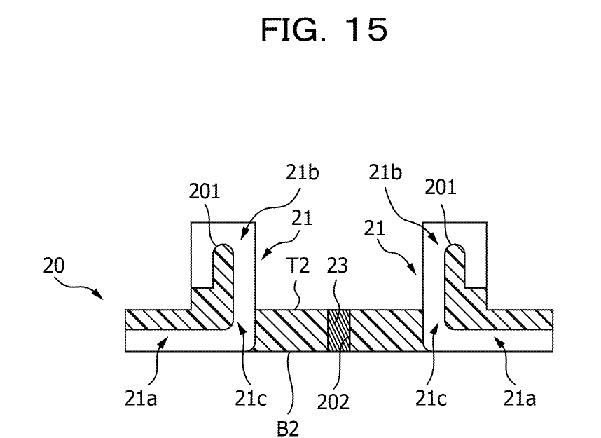

FIG. 15 illustrates one example of a sectional view of a state before the terminals are attached to the header illustrated in FIG. 14. As illustrated in FIG. 15, the main body 20 on the side of the header 2 includes straight line grooves 21a that are formed in the bottom surface B2 and are along the front-rear direction and U-shape engagement grooves 21b formed in the respective bump parts 201. The main body 20 on the side of the header 2 includes through-holes 21c that extend from the bottom surface B2 to the top surface T2 to cause the straight line groove 21a and the engagement groove 21b to communicate with each other. The straight line grooves 21a of the main body 20 are formed to be capable of accepting the straight line parts 221 of the respective terminals 22. The engagement grooves 21b of the main body 20 are formed to be capable of engaging with the folded-back parts 222 of the respective terminals 22 and the through-holes 21c of the main body 20 are formed to be capable of accepting the intermediate parts 22i of the respective terminals 22. As above, the terminal putting part 21 on the side of the header 2 includes the above-described straight line groove 21a, engagement groove 21b, and through-hole 21c. In FIG. 14, each terminal 22 is put on the main body 20 by press-fitting.

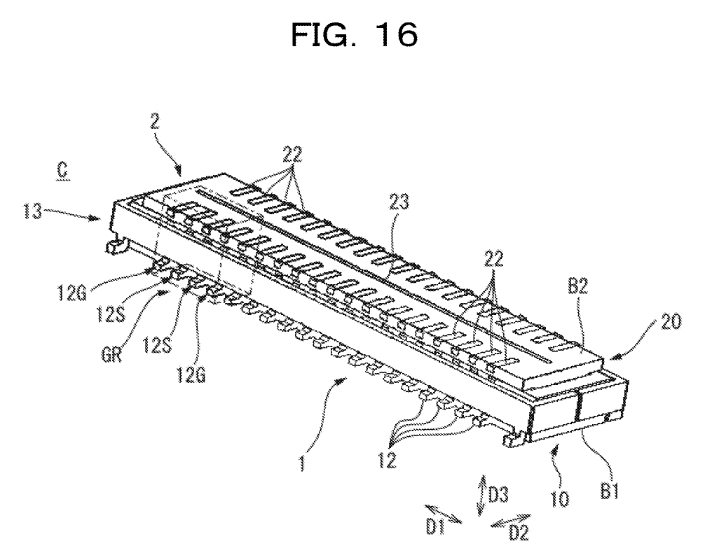

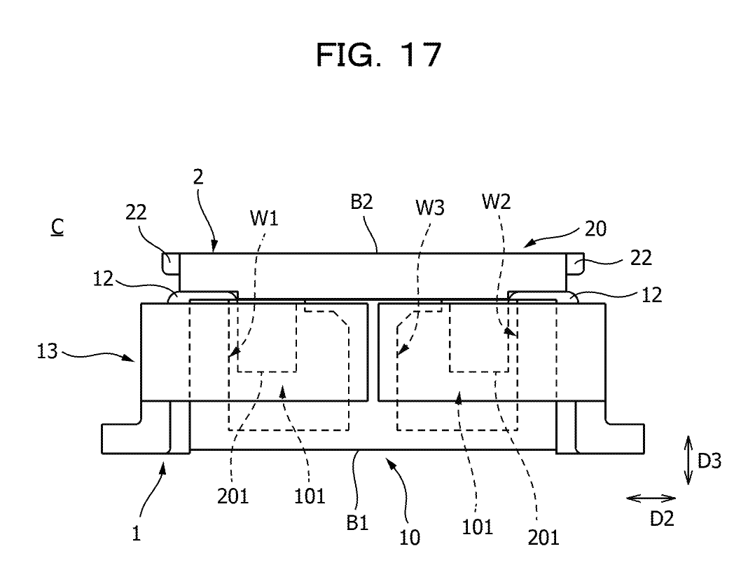

FIG. 16 illustrates one example of a perspective view of a connector. Although the connector illustrated in FIG. 16 may be the connector C illustrated in FIG. 1, FIG. 16 illustrates a state in which the socket 1 is joined to the header 2 in contrast to FIG. 1. FIG. 17 illustrates one example of a front view of the connector of FIG. 16. As illustrated in FIG. 17, in the connector C, each bump part 201 of the header 2 is inserted into the corresponding recess part 101 of the socket 1 and thereby the header 2 and the socket 1 are joined to each other. The plural terminals 22 on the side of the header 2 are disposed similarly to the plural terminals 12 on the side of the socket 1. Thus, when the header 2 is joined to the socket 1, the plural terminals 22 on the side of the header 2 get contact with the plural terminals 12 on the side of the socket 1.

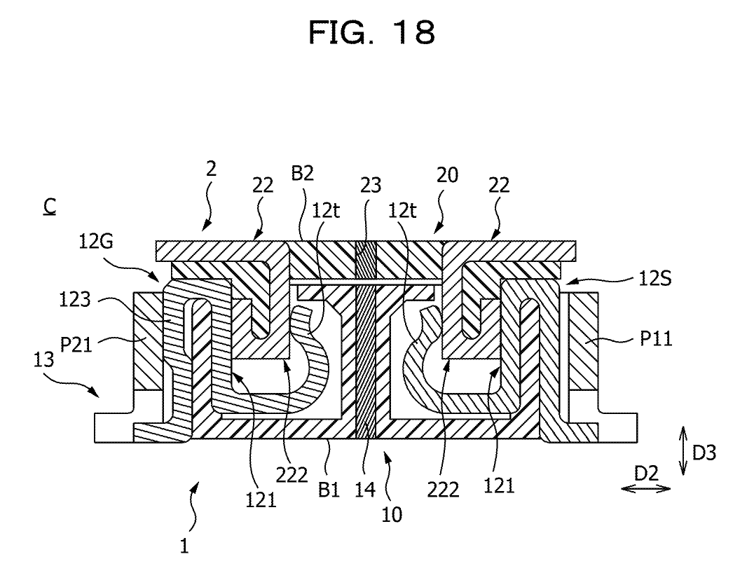

FIG. 18 illustrates one example of a sectional view perpendicular to the left-right direction of the connector of FIG. 16. The section of the socket 1 in FIG. 18 may be the same as the section of the socket 1 in FIG. 7 and the section of the header 2 in FIG. 18 may be the same as the section of the header 2 in FIG. 14. As illustrated in FIG. 18, when the header 2 is joined to the socket 1, the folded-back part 222 of each terminal 22 on the side of the header 2 enters the space between the folded-back part 121 and the tip part 12t of a respective one of the terminals 12G and 12S on the side of the socket 1. Thus, each terminal 22 on the side of the header 2 is electrically coupled to the respective one of the terminals 12G and 12S on the side of the socket 1.

At the right part of the section in FIG. 18, in the connector C, the signal terminal 12S on the side of the socket 1 is disposed between the central shield 14 and the extending part P11 of the side shield 13. Because the central shield 14 and the extending part P11 of the side shield 13 are juxtaposed in the front-rear direction, the signal terminal 12S is shielded on both sides in the front-rear direction. In FIG. 18, the central shield 14 on the side of the socket 1 and the central shield 23 on the side of the header 2 are separated in the upward-downward direction. However, the two central shields 14 and 23 may be disposed to get contact with each other when the socket 1 is joined to the header 2. This might improve the shield effect at the central part of the connector C in the front-rear direction.

At a part surrounded by a chain line in FIG. 16, in the connector C, a group GR of two signal terminals 12S adjacent in the left-right direction is disposed between two ground terminals 12G lined up in the left-right direction. For example, in the connector C, the group GR of the signal terminals 12S is shielded by the two ground terminals 12G on both sides in the left-right direction. The above-described group GR of the signal terminals 12S may be referred to as the signal terminal group GR hereinafter. As illustrated in FIG. 18, each signal terminal 12S is shielded also on both sides in the front-rear direction by the side shield 13 and the central shield 14. Therefore, in the connector C, the signal terminal group GR is shielded from four sides by the two ground terminals 12G and the two shields 13 and 14. Thus, the influence of radiation noise that the signal terminal group GR suffers from other signal terminals 12S might be alleviated. Similarly, in the connector C, the influence given to other signal terminals 12S by radiation noise of the signal terminal group GR might be alleviated. The connector C might be compatible with even high-speed signal transmission at several hundreds of megahertz to several gigahertz for example.

As described with reference to FIG. 7 to FIG. 10 and so forth, in the connector C, each of the signal terminals 12S and the ground terminals 12G on the side of the socket 1 is formed to be capable of being put on any of the terminal putting parts 11 on the main body 10. Therefore, in the connector C, the arrangement of the signal terminals 12S and the ground terminals 12G on the socket 1 might be arbitrarily changed by merely interchanging the signal terminal 12S or the ground terminal 12G put on each terminal putting part 11 of the socket 1. For example, a process of putting the signal terminal 12S and the ground terminal 12G on the side of the socket 1 on the main body 10 is carried out by various automatic machines that operate in accordance with a program. Therefore, in the connector C, the terminal arrangement on the socket 1 might be arbitrarily changed by merely changing the program without using large-scale equipment such as a mold, a molding machine, and a jig corresponding to the new terminal arrangement.

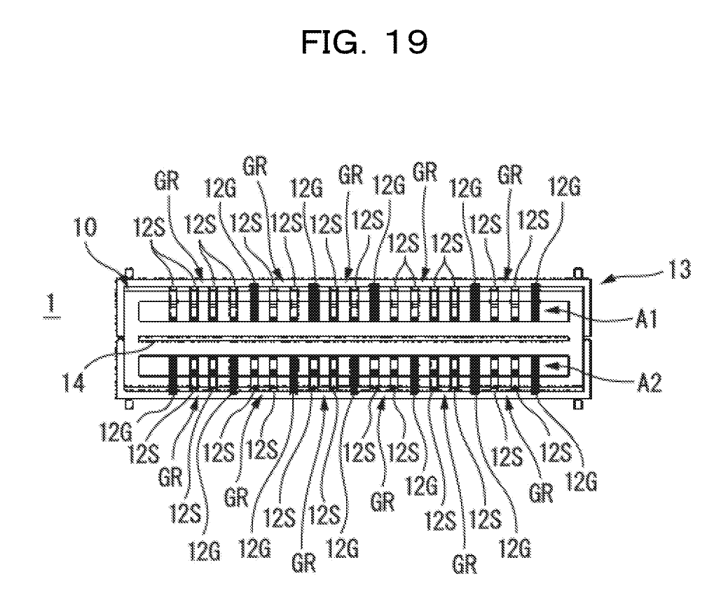

FIG. 19 illustrates one example of a top view of the socket illustrated in FIG. 16. For convenience, the ground terminals 12G are blacked out in FIG. 19. As illustrated in FIG. 19, the plural ground terminals 12G are included in the respective terminal rows A1 and A2 on the socket 1, and the signal terminal group GR including two or more signal terminals 12S is disposed between two ground terminals 12G lined up in the left-right direction. For example, in the first terminal row A1 in FIG. 19, five ground terminals 12G are included and the signal terminal groups GR including two or four signal terminals 12S are each disposed between two ground terminals 12G lined up in the left-right direction. For example, in the first terminal row A1 in FIG. 19, the signal terminals 12S are shielded by twos or fours by the ground terminals 12G. In the second terminal row A2 in FIG. 19, seven ground terminals 12G are included and two signal terminals 12S are disposed between two ground terminals 12G lined up in the left-right direction. For example, in the second terminal row A2 in FIG. 19, the signal terminals 12S are shielded two by two by the ground terminals 12G.

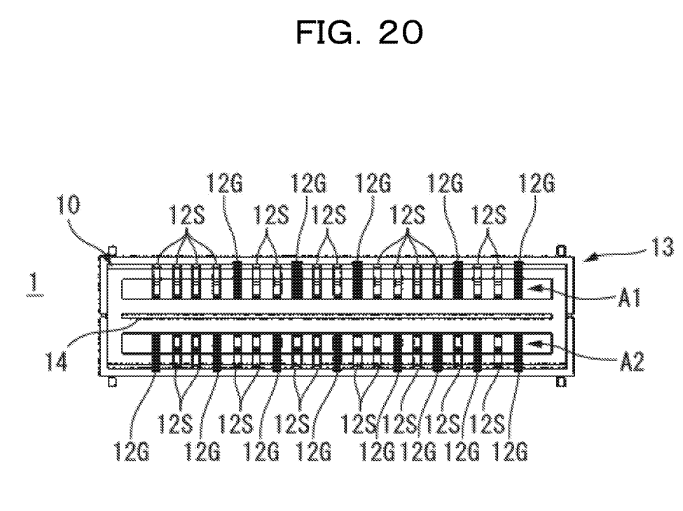

FIG. 20 illustrates one example of a top view of a socket of a connector. The connector illustrated in FIG. 20 is different from the connector C illustrated in FIG. 1 in the terminal arrangement on the socket 1. The terminal arrangement in the first terminal row A1 illustrated in FIG. 20 may be substantially the same as the example illustrated in FIG. 19. The terminal arrangement in the second terminal row A2 includes a part in which the signal terminals 12S are disposed between the ground terminals 12G two by two and a part in which the signal terminals 12S are disposed between the ground terminals 12G one by one. For example, the signal terminals 12S are shielded two by two by the ground terminals 12G in one part of the second terminal row A2, and the signal terminals 12S are shielded one by one by the ground terminals 12G in the remaining part of the second terminal row A2.

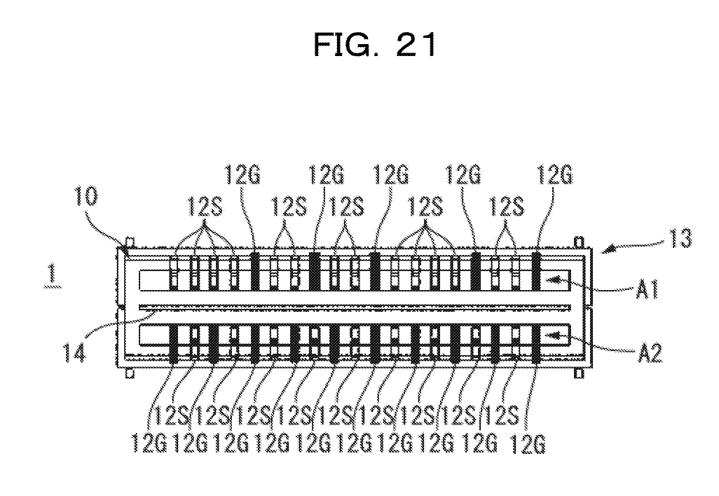

FIG. 21 illustrates one example of a top view of a socket of a connector. The connector illustrated in FIG. 21 is different from the connector C illustrated in FIG. 1 in the terminal arrangement on the socket 1. The terminal arrangement in the first terminal row A1 illustrated in FIG. 21 may be substantially the same as the example illustrated in FIG. 19. In the second terminal row A2 illustrated in FIG. 21, the ground terminals 12G and the signal terminals 12S are alternately disposed one by one. For example, the signal terminals 12S are shielded one by one by the ground terminals 12G over the entire length of the second terminal row A2.

In the above-described connector C, by changing the terminal arrangement on the socket 1, an arbitrary number of signal terminals 12S may be collectively shielded or the individual signal terminals 12S may be separately shielded. In the case of the former, the number of signal terminals 12S collectively shielded might be arbitrarily changed in the socket 1 (see the first terminal row A1 in FIG. 19 to FIG. 21). In the case of the latter, only partial signal terminals 12S in the socket 1 may be individually shielded (see the second terminal row A2 in FIG. 20) or all signal terminals 12S in the socket 1 may be individually shielded (see the second terminal row A2 in FIG. 21).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A connector socket comprising:
a main body including a plurality of terminal putting parts;
a plurality of terminals put on the respective terminal putting parts; and
a first shield member attached to the main body,
the plurality of terminals includes one or more ground terminals each including a protruding part that protrudes to outside of the main body and is in contact with the first shield member, and one or more signal terminals that are not in contact with the first shield member,
each of the one or more ground terminals and each of the one or more signal terminals are formed to be attachable to the plurality of terminal putting parts.

2. The connector socket according to claim 1, wherein
the plurality of terminals are disposed on two rows on the main body, and
the connector socket further comprises a second shield member attached to the main body in such a manner as to be located between a first row and a second row of the plurality of terminals.

3. The connector socket according to claim 1, wherein
at least one of the one or more signal terminals is disposed between two ground terminals adjacent to each other among the one or more ground terminals.

4. The connector socket according to claim 1, wherein
each of the one or more ground terminals has the same shape as one of the one or more signal terminals except for the protruding part.

5. The connector socket according to claim 1, wherein
each of the plurality of terminals is put on the main body in such a state as to engage with the respective terminal putting parts.

6. The connector socket according to claim 1, wherein
each of the plurality of terminals is formed monolithically with the main body.

7. A connector comprising:
a connector socket; and
a connector header joinable to the connector socket;
the connector socket including:
a main body including a plurality of terminal putting parts;
a plurality of terminals put on the respective terminal putting parts; and
a first shield member attached to the main body,
the plurality of terminals includes one or more ground terminals each including a protruding part that protrudes to outside of the main body and is in contact with the first shield member, and one or more signal terminals that are not in contact with the first shield member,
each of the ground terminals and each of the signal terminals are formed to be attachable to the plurality of terminal putting parts.

8. The connector according to claim 7, wherein
the plurality of terminals are disposed on two rows on the main body, and
the connector socket further includes a second shield member attached to the main body in such a manner as to be located between a first row and a second row of the plurality of terminals.

9. The connector according to claim 8, wherein
the connector header includes a header main body, a plurality of header terminals disposed on two rows on the header main body, and a third shield member attached to the header main body in such a manner as to be located between a first row and a second row of the plurality of header terminals, and
the second shield member gets contact with the third shield member when the connector socket is joined to the connector header.

10. The connector according to claim 7, wherein
at least one of the one or more signal terminals is disposed between two ground terminals adjacent to each other among the one or more ground terminals.

11. The connector according to claim 7, wherein
Each of the one or more ground terminals has the same shape as one of the one or more signal terminals except for the protruding part.

12. The connector according to claim 7, wherein
each of the plurality of terminals is put on the main body in such a state as to engage with the respective terminal putting parts.

13. The connector according to claim 7, wherein
each of the plurality of terminals is formed monolithically with the main body.
